(19) United States
(12) Patent Application Publication
(10) Pub. No.: US 2004/0048075 A1
(43) Pub. Date: Mar. 11, 2004

(54) Surface plasmon-excitable granular thin film of noble metal

(76) Inventors: Junji Tominaga, Tsukuba-shi (JP); Masashi Kuwahara, Tsukuba-shi (JP); Takayuki Shima, Tsukuba-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/457,481

(22) Filed: Jun. 10, 2003

(30) Foreign Application Priority Data
Jun. 14, 2002 (JP) 2002-174414

(51) Int. Cl. B32B 15/00; B32B 17/06

(52) U.S. Cl. 428/434

(57) ABSTRACT

The present invention proves a surface plasmon-excitable thin film of fine noble metal particles which has a structure in which the fine noble metal particles having uniform and nanometer order particle diameters are distributed at appropriate intergranular distances and which is capable of stably supplying surface plasmon to a nanometer range and a high density optical recording medium and a highly sensitive molecular sensor using the same. The thin film is obtained by a reducing treatment of a noble metal oxide thin film formed on a substrate in a hydrogen-containing gas and comprises distributed fine noble metal particles with an average particle size of 50 nm or smaller at intergranular distances of 10 to 30 nm.

### BACKGROUND OF THE INVENTION

The present invention relates to a thin film of fine granules of a noble metal excellent in a surface plasmon-excitable property and a high-density optical recording medium and a highly sensitive optical molecular sensor by utilization of this thin film.

Recording media and sensors using light have been known well so far and with respect to conventional optical recording techniques and sensor techniques based on optical systems using far field light beams, it is theoretically impossible to lower the resolution limit to λ/(4NA) or lower attributed to the light wavelength λ and the numerical aperture NA of a lens. That is, the resolution limit is regulated according to diffraction limit λ/(2NA) and any of the conventional optical recording media and optical sensors using the far field light beams cannot overcome the limit and thus cannot be expected to have resolution power in a nanometer range.

Aiming to make optical recording and sensor techniques in the nanometer range possible without being limited to such a diffraction limit, investigations using different types of light beams, so-called near field light, have been actively carried out. For example, Betzig et al. performed optical resolution in a nanometer size range using a near field optical microscope [Betzig et al., Science, 251, 1468(1991); Science, 257, 189(1992); Nature, 365, 40(1994)], however it was practically impossible to record a small mark on an optical recording medium rotating at a high speed. Further, since it has been theoretically known that the maximum detection sensitivity can be obtained in the case where the optical aperture of a probe for measurement is approximately same as the size of a small object to be measured, if the object has a nanometer size, the photosensitivity is extremely decreased and in order to carry out spectroscopic measurement, long time measurement and signal accumulation technique are required.

As a method for solving such technical problems and reinforcing the electric field of the light for measurement surface, a method utilizing surface plasmon has recently been proposed (H. Raether, Surface plasmons on smooth and rough surfaces on gratings, published by Springer Verlag, 1988, Germany.

This surface plasmon method, in general, comprises a process of generating an electric field of light transmitted along the plane direction of the total reflection surface by using a prism and laser beam arranged in total reflection conditions. Since many of input light beams are intensely converted into surface plasmon beams at a certain narrow angle especially under the total reflection conditions, the method has been applied to gas sensors and the like.

However, in order to detect molecules by conforming the laser beam to the prism at a certain narrow angle and detecting the angle under narrow plasmon beam resonance conditions, it is required to make the length of the overall laser beam path long (about 10 cm or longer) and obtain angle resolution power. Accordingly, the apparatus becomes relatively large and costly owing to the necessity of an angle adjustment mechanism.

Meanwhile, a method for depositing island-like particles of silver and the like on a substrate by a vacuum film forming method and the like has been known as well, however it has disadvantages that control of the thickness of a film to be formed is difficult; the dispersion of particle sizes becomes wide; and that although surface plasmon can be generated locally, uniform generation in the overall substrate is impossible.

Recently, a technique for overcoming such a situation and efficiently generating surface plasmon only in a site upon which laser beam is converged by silver particles generated in thermal decomposition of silver oxide has been developed to apply it to high density recording optical signal regeneration or to molecular sensors [H. Fuji et al., Jpn. J. Appl. Phys., 390, 980-981(2000), D. Buechel et al., Appl. Phys. Lett., 79, 620-622(2001)].

Also in the decomposition step of silver oxide by laser heating, there are problems that since the particle sizes of silver fluctuate with the lapse of beam convergence time and grain growth, plasmon beam is attenuated and simultaneously detection signal intensity is decreased to make it impossible to obtain a stable plasmon generation source and that signals from an optical recording medium are attenuated and the duration of Raman signals are fluctuated.

### SUMMARY OF THE INVENTION

The present invention has an object to provide a surface plasmon-excitable noble metal thin film of fine noble metal particles having uniform and fine nanometer particle sizes in a narrow particle size distribution and appropriate intergranular distances and capable of stably supplying surface plasmon to a nanometer range and a high density optical recording medium and a highly sensitive optical molecular sensor using the thin film.

The above-mentioned purpose can be accomplished by the present invention as follows.

(1) A surface plasmon-excitable noble metal thin film having a finely granular structure comprising uniformly distributed fine metal particles with an average particle diameter of 50 nm or smaller and obtained by a reducing treatment of a noble metal oxide thin film in a hydrogen-containing gas.

(2) The surface plasmon-excitable thin film according to (1) mentioned above, characterized in that the respective fine metal particles are distributed at intergranular distances of 15 to 25 nm.

(3) The surface plasmon-excitable thin film of fine noble metal particles according to (1) or (2) mentioned above, characterized in that the hydrogen-containing gas is a mixed gas of hydrogen with either oxygen or a rare gas.

(4) The surface plasmon-excitable thin film of fine noble metal particles according to (3), characterized in that the ratio of the hydrogen flow rate to the overall flow rate of the mixed gas is 0.4 or higher.

(5) The surface plasmon-excitable thin film of fine noble metal particles according to any one of (1) to (4) mentioned above, characterized in that the noble metal oxide thin film is a thin film of an oxide of a single metal selected from silver, platinum or palladium, or an alloy thereof and formed by a vacuum film forming method.

(6) An optical recording medium comprising the surface plasmon-excitable thin film of fine noble metal particles according to any one of (1) to (5) mentioned above.

(7) The optical recording medium according to (6) mentioned above, characterized in that the optical recording medium is a phase-transition type optical recording medium.

(8) An optical molecular sensor comprising the surface plasmon-excitable thin film of fine noble metal particles, according to any one of (1) to (5) mentioned above, formed on a substrate and characterized by utilization of the Raman optical amplification of localized plasmon exhibited by said surface plasmon-excitable thin film of fine noble metal particles.

(9) The optical molecular sensor according to (8) mentioned above, characterized in that the substrate is an optical fiber.

### BRIEF DESCRIPTION OF THE DRAWING

FIG. 1 is a graph showing the contrast between plasmon reflectivity characteristics of a silver oxide thin film (Sample 1) and a fine silver particle thin film (Sample 2) of the present invention.

FIG. 2A is a SEM photograph of the silver oxide thin film (Sample 1).

FIG. 2B is a SEM photograph of the fine silver particle thin film (Sample 2) of the present invention.

FIG. 3 is a graph showing the composition ratios of silver and oxygen in the fine silver particle thin film (Sample 2) as a function of the ratio of partial pressure of hydrogen gas.

FIG. 4 is a SEM photograph of the silver particle thin film (Sample 4) produced by heating treatment at 250° C.

FIG. 5 is a graph showing the alteration of Raman signals of benzoic acid molecule with lapse of time measured by an analysis sensor 1 comprising the fine silver particle thin film.

FIG. 6 is a graph showing the alteration of Raman signals of benzoic acid with lapse of time measured by an analysis sensor 2 comprising the silver oxide thin film.

FIG. 7 is a Raman signal of benzoic acid measured by an analysis sensor 3 produced by thermal decomposition.

### DETAILED DESCRIPTION OF THE PREFERRED EMBODIMENTS

A surface plasmon-excitable thin film of fine noble metal particles of the present invention can be obtained by forming a noble metal oxide thin film preferably by vacuum film formation followed by carrying out a reducing treatment thereof in a hydrogen-containing gas.

The surface plasmon-excitable thin film comprises uniformly distributed fine noble metal particles with an average particle diameter of 50 nm or smaller, preferably 40 nm or smaller, further preferably 30 nm or smaller.

The respective fine noble metal particles are uniformly distributed at intergranular distances of 10 to 30 nm, preferably 15 to 25 nm.

Although the thermal decomposition of a silver oxide thin film by conventional laser beams heating as described above is a very efficient method, the crystal grains gradually grow in the decomposition steps and the beam intensity of surface plasmon is attenuated. That is, with respect to a thin film obtained by a thermal decomposition method of silver oxide, the particle size of silver particles changes with lapse of time and attributed to that, neighboring particles are firmly brought into contact with one another and diffusion growth owing to heat is promoted to result in small beam intensity of the surface plasmon, and accordingly it is observed that signals from an optical recording medium are attenuated and the above-mentioned Raman signals are fluctuated with lapse of time.

Besides, with respect to a surface plasmon-excitable thin film according to the present invention, fine noble metal particles with nanometer sizes are uniformly dispersed and neighboring respective fine metal particles are distributed while being kept from one another at optimum distances of 15 to 25 nm, so that diffusion growth of particles by heating can be suppressed and stable surface plasmon beams can be exhibited.

A method for forming a surface plasmon-excitable thin film of a finely granular noble metal according to the present invention will be summarized.

First, a noble metal oxide thin film to be a precursor is formed on a substrate. As the noble metal oxide thin film, an oxide thin film of a single metal selected from silver, platinum, and palladium or an alloy thereof is used.

As the substrate, any of conventionally employed substrates can be used and appropriately selected based on the purposes and the application fields of a thin film to be obtained. For example, glass and a plastic resin such as polycarbonate and the like used for optical disks may be selected.

The film forming method of the noble metal oxide thin film is not particularly limitative, however a vacuum film forming method is preferably employed. The vacuum film forming method may be any conventionally known method, for example, DC sputtering such as RF reactive magnetron sputtering and the like; vacuum vapor deposition; ion plating; and the like. The apparatus for the film formation is not particularly limitative.

The composition of the noble metal oxide obtained by the film formation can be determined by the concentration of oxygen gas used in the vacuum film forming method and, in the case of high oxygen concentration, an oxygen-rich oxide thin film can be obtained and, in the case of low oxygen concentration, a noble metal-rich thin film can be obtained. Further, since the oxygen gas concentration and/or the oxygen gas introduction quantity is a basic factor for determining the size of fine particles composing the noble metal thin film after the reduction by hydrogen-containing gas, it is preferable to determine the oxygen gas concentration and its introduction quantity beforehand so as to obtain a fine particles with a desired size.

The film thickness of the noble metal oxide thin film is not particularly limitative, but it is generally about 1 to 1,000 nm.

Next, in the present invention, the thus formed noble metal oxide thin film is subjected to reduction treatment by a hydrogen-containing gas.

The hydrogen-containing gas may include hydrogen gas alone and also a mixed gas of hydrogen with oxygen or a rare gas such as argon and the like.

The reduction treatment can possibly be carried out by a wet-process reduction method using a HF solution and the like, however hydrogen reduction treatment under reduced pressure using a vacuum apparatus is free from a risk of explosion and thus safe and does not require heating, so that it is very efficient and capable of carrying out the reduction treatment uniformly in a wide surface area in the case where a plastic substrate is employed. It is the most preferable to employ a reactive ion etching method for carrying out reduction.

The electric power to be consumed for etching is determined by the distance between electrodes and the surface area of electrodes and therefore not particularly limitative and in general, electric power of about 100 W is sufficient. If the input power is too high, even the noble metal is removed by oxygen to result in impossibility of formation of a desired thin film of fine noble metal particles.

Next, a formation means of the surface plasmon-excitable thin film of fine noble metal particles will be described in details while the case of using silver as the noble metal for the thin film being exemplified. It is no need to say a desired thin film can be obtained in the same manner in any case of using another noble metal such as platinum, palladium and the like.

First, a silver oxide thin film to be a precursor is formed. The silver oxide thin film is formed by RF reactive magnetron sputtering method in a vacuum chamber. The apparatus for forming the silver oxide thin film is not particularly limitative. DC type sputtering, vacuum vapor deposition, ion plating or any other method may be used. The composition at the time of the film formation can be set by controlling the mixing ratio of argon gas and oxygen gas to be introduced into the sputtering chamber. The silver oxide thin film to be formed is a mixture of Ag₂O and AgO and if the oxygen amount is decreased, a silver-rich silver oxide thin film is obtained and on the contrary, if the oxygen amount is increased, an oxygen-rich thin film is obtained. The former shows metallic reflection properties and the latter shows brown and dielectric properties. The gas flow rate at the time of silver oxide thin film formation determines the size of the silver particle agglomerates. The film thickness of the film formation is not particularly limitative, however it may be controlled to be about 1 nm to 1,000 nm.

Next, the thus formed silver oxide thin film is introduced into a reactive ion etching apparatus for reducing the silver oxide thin film and once the pressure is decreased to vacuum of 1×10⁻³ Pa or lower and then together with oxygen or a rare gas such as argon and the like, hydrogen gas is introduced into the apparatus. Prior to the mixed gas introduction, it is preferable to carry out fluorination treatment using CF₄ and the like in the vacuum apparatus. With respect to the flow rate ratio of hydrogen gas to oxygen gas or a rare gas such as argon and the like, the proportion of the partial pressure of hydrogen to the total pressure is most preferably 0.4 or higher, especially 0.5 or higher. The etching pressure in the apparatus is preferably 0.1 Pa or higher, however it is not particularly limitative. The electric power to be consumed for the etching is not particularly limitative since it is determined based on the distance of electrodes and the surface area of the electrodes, however, in general, about 100 W electric power is sufficient. If the input electric power is too high, even silver is removed by oxygen to make it difficult to obtain a desired thin film of fine silver particle. In the case of a silver oxide thin film with a thickness of 100 nm, the etching treatment duration is about 5 to 10 minutes.

The optical properties and the structural differences of the thin film of fine silver particles and the silver oxide thin film obtained in the above-mentioned manner can be observed by plasmon absorption that is particular for silver and appears in the reflectivity and an electron microscope image. In the case of the silver oxide thin film, no plasmon resonance at 400 nm or shorter wavelength, which a silver thin film shows, is observed, whereas the thin film of fine silver particles produced by the reactive etching method exhibits sharp decrease of the reflectivity and thus the formation of silver particles can be confirmed. Further, from an electron microscope photograph, it is confirmed that the fine silver particle thin film comprising silver particles with a particle diameter of 20 nm and uniformly distributed at 2 to 3 nm intergranular distance is formed.

The surface plasmon-excitable thin film of a finely granular noble metal according to the present invention shows outstanding functions, that is, the thin film is capable of stably supplying surface plasmon beams to a nanometer range and exhibiting localized plasmon that remarkably amplifies Raman signals, so that the surface plasmon-excitable thin film can be utilized for a high density optical recording medium and a highly sensitive optical sensor.

The principle of signal regeneration of a mark below the image resolution limit by utilizing the surface plasmon-excitable thin film of the finely granular noble metal according to the present invention for a phase transition type optical recording medium will be described.

A guide groove for guiding laser beam is formed beforehand by grooving the surface of an optical recording medium. A dielectric to be a protective film is formed on the optical recording medium by a sputtering method. Next, a phase change recording film to be a recording film is formed similarly. GeSbTe or AgInSbTe is preferable for the material for the recording film and it may contain a trace amount of metal additives. The recording film is not particularly limitative to the phase change recording film but a magnetooptical recording film may be applied. Further a protective film is formed similarly on the top part of the recording film. The thickness of the protective film is adjusted to be 10 nm to 100 nm. If the thickness exceeds 100 nm, the synergetic effect with near field light or surface plasmon beam is attenuated and if it is thinner than 10 nm, the film becomes thermally instable. The thus formed optical recording medium is used for high-speed recording of marks below the resolution limit on the recording film by an evaluation apparatus for high-density optical disk recording. Here, the rotation speed and the like are not particularly standardized. In the optical recording on the phase change recording film, the thermal distribution generated by converged beam is a factor of determining the size of a recording mark and the size of the recording mark is not affected by the diffraction limit of the beam. Such a recording is generally called “brush-tip recording”. However, since the size of the recorded mark is below the diffraction limit, even if the laser power is changed at the time of regeneration, the recorded signal cannot be regenerated. Therefore, a fine silver particle thin film is formed by the above-mentioned method on the protective film. After that, another protective film is further formed. The thickness of the protective film is not particularly limitative and it is sufficient if the protective film can inhibit the grain growth of the fine silver particles of the thin film by the heat generation effect by the laser at the time of signal regeneration. The thus completed optical recording medium is again set in the evaluation apparatus for the high density optical disk recording and while the recording medium being rotated at a high speed, laser beam is converged upon the guide groove where the mark below the resolution limit is recorded. If the power of the laser beam is small, the signal of the mark below the resolution limit cannot be regenerated, however if the recording power is sufficiently increased, the mark below the resolution limit can be stably regenerated with a high signal intensity.

Next, a method for identifying an organic molecule contained at a low concentration in a solution by utilizing the surface plasmon-excitable thin film of fine noble metal particles according to the present invention for a highly sensitive optical sensor will be described.

A fine silver particle thin film is formed on the surface of a Si substrate in the same manner as described above. The film thickness is not particularly limitative. A sample produced in such a manner is employed as an analysis sensor. The analysis sensor is immersed in a solution produced by dissolving an organic compound, for example, benzoic acid at a concentration of 10⁻³ M in methanol or isopropyl alcohol and microscopic Raman spectrophotometry is carried out using a lens with NA about 0.6. While only Raman signals of the solvent molecule are observed in a blank experiment using a Si substrate alone, in the case of using the above-mentioned analysis sensor, Raman signals of benzoic acid molecule can be detected with an extremely high sensitivity as compared with the Raman signals of the solvent molecule. In that case, even if the concentration of the solution is decreased to 10⁻⁸ M, signals of benzoic acid can be detected with a high sensitivity.

A reflection type or a transmission type microscopic Raman apparatus can detect the Raman signals and can be employed without any particular limit.

For example, the fine silver particle thin film may be formed on the surface of an optical fiber or on the surface of an optical fiber comprising only a core but no clad layer of an optical fiber to obtain an optical fiber which may be used for detecting Raman signals scattered in the inside of the obtained optical fiber.

Further, Raman signal beams generated in the surface of the fine silver particle thin film can be detected by introducing laser beams necessary for the microscopic Raman spectrophotometry from an end surface of the optical fiber but not from the outside of the solution and guiding the laser beams to the point where the fine silver particle thin film is formed.

In the following, the present invention is described in more detail by way of Examples.

### EXAMPLE 1

A silver oxide thin film was formed on a Si substrate by RF magnetron sputtering method. The film formation conditions were controlled as follows; using a 2-inch Ag target; an oxygen gas flow rate ratio of 0.4 O₂:0.6 Ar; the film formation pressure 0.5 Pa; electric power 100 W; and the film thickness of the silver oxide thin film of 100 nm; to produce a silver oxide thin film (Sample 1).

Next, Sample 1 was transported to a reactive ion etching apparatus and after the inside pressure of the apparatus was decreased to 1×10⁻³ Pa or lower, the gas flow rates were controlled to be 30 sccm for hydrogen and 10 sccm for oxygen (hydrogen gas flow rate ratio: 0.75) and 100 W electric power was applied for 5 minutes to carry out etching and obtain a fine silver particle thin film (Sample 2) of the present invention.

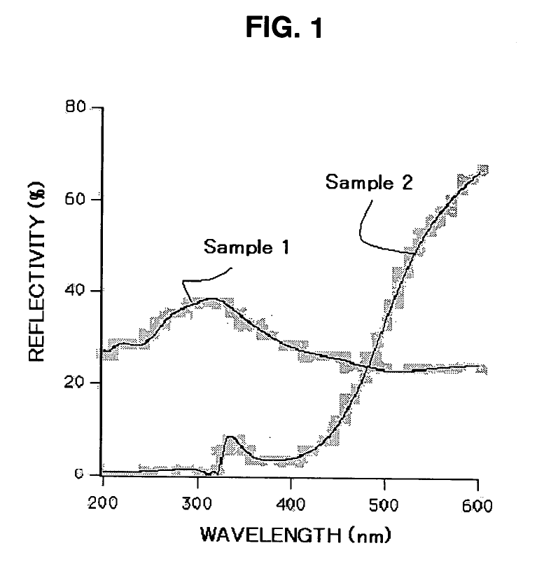

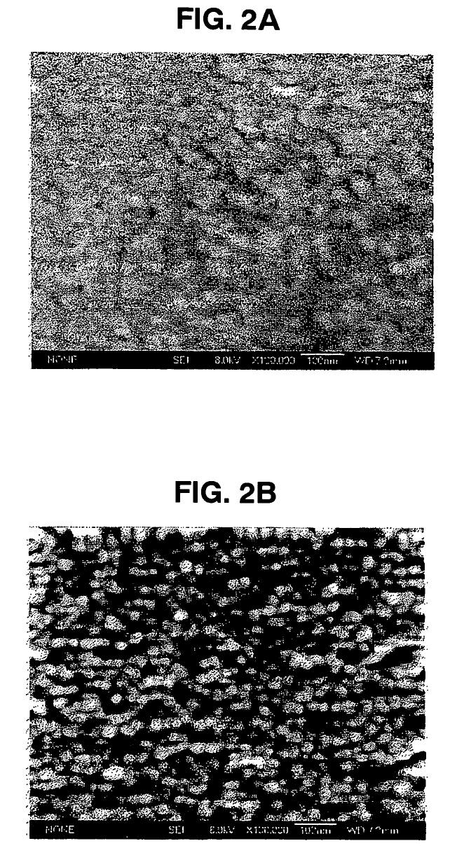

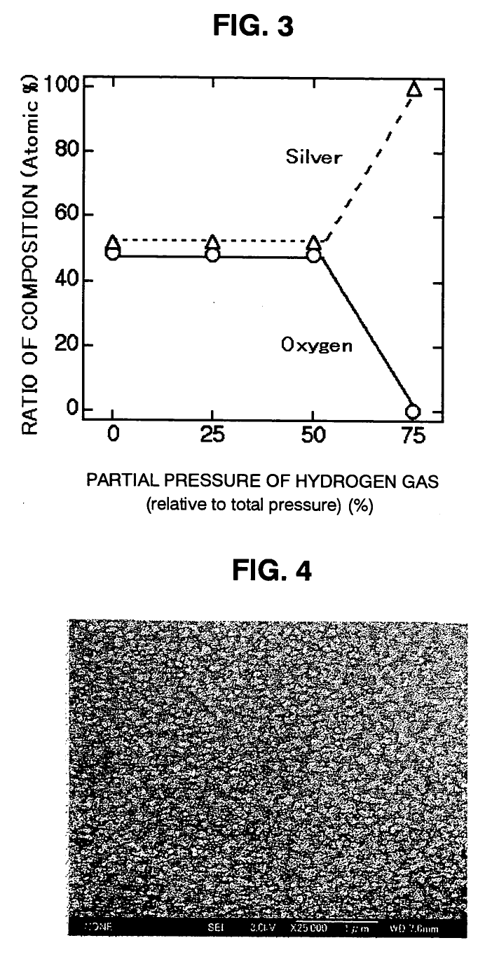

The reflectivities of Sample 1 and Sample 2 are shown in FIG. 1 and their SEM photographs are shown in FIG. 2A and FIG. 2B, respectively. It can be found from FIG. 1 that since reflectivity characteristics of the silver oxide thin film significantly change, the silver oxide thin film was reduced to a film having absorption at the plasmon wavelength (326 nm) which is a particular characteristic for silver. FIG. 2B makes it clear that Sample 2 of the present invention had a structure in which fine silver particles with an about 20 nm particle diameter were distributed uniformly at 2 to 3 nm intergranular distances. FIG. 3 shows the silver/oxygen composition when the hydrogen flow rate ratio was changed. It can be understood that if hydrogen flow rate ratio became 0.4 or higher (in FIG. 3, 0.5), the production efficiency of the fine silver particle thin film was increased.

### COMPARATIVE EXAMPLE 1

A silver oxide thin film was formed on a Si substrate in the same manner as in Example 1 by using RF magnetron sputtering. The film formation conditions were controlled as follows; using a 2-inch Ag target; an oxygen gas flow rate ratio of 0.4; the film formation pressure of 0.5 Pa; electric power of 100 W; and the film thickness of the silver oxide thin film of 100 nm; to produce a silver oxide thin film (Sample 3).

Next, Sample 3 was subjected to thermal decomposition at a temperature of 250° C. in air to produce a silver thin film (Sample 4).

An electron microscopic photograph of Sample 4 is shown in FIG. 4 and makes it clear that, although the film obtained was a silver particle thin film having a granular silver texture, the particle diameters of the silver particles of the film were uneven and not uniform.

### EXAMPLE 2

A 170 nm-thick dielectric thin film consisting of ZnS and SiO₂ (the atomic composition ratio of 0.8:0.2) was formed by a sputtering method on a transparent polycarbonate substrate for an optical recording medium, which had a diameter of 12 cm and was grooved beforehand to have a guide groove for converged laser and thereon, a 20 nm-thick phase change recording film consisting of AgInSbTe was formed similarly by a sputtering method. A 40 nm-thick dielectric thin film with the same composition as that of the above-mentioned dielectric film was formed on the phase change recording film by a sputtering method to obtain an optical recording medium. The optical recording medium was set on a drive tester capable of evaluating properties of an optical disk such as DVD and the like and recording was carried out using signals of 30 MHz frequency with power of 6.0 mW at a linear velocity of 6.0 m/s. The recorded marks were rows of pits of 100 nm; duty ratio was 50%; the laser wavelength of the drive tester was 635 nm; the numerical aperture NA of a lens was 0.6; and the diffraction limit was 540 nm (theoretical resolution degree was 270 nm). After a fine silver particle thin film was formed again on the optical recording medium, on which such small marks were recorded as mentioned above, by a sputtering method in a vacuum apparatus under the same conditions as those of Example 1, an optical recording medium 1 bearing the fine silver particle thin film was obtained. The optical recording medium 1 was again set in the drive tester and while the medium being rotated at a linear velocity of 6.0 m/s, laser beam was converged on the guide groove of the recorded mark and reading of the recorded marks was tried while changing the reading-out power. With the reading-out power of 1.0 mW, no regeneration signal was obtained at all and the signal intensity was 0 dB, whereas in the case the regeneration power was increased to 4.0 mW, the recorded marks can be regenerated with signal intensity of 40 dB.

In an experiment for a thin film of Comparative Example 1 having the same film thickness of 100 nm in place of the above-mentioned fine silver particle thin film, even if the regeneration power was increased to 8.0 mW, the signal intensity of the recorded marks was as it was, 0 dB, and no regeneration signal was obtained at all.

### COMPARATIVE EXAMPLE 2

A 170 nm-thick dielectric thin film consisting of ZnS and SiO₂ (the atomic composition ratio of 0.8:0.2) was formed by a sputtering method on a transparent SiO₂ substrate for an optical recording medium, which had a diameter of 12 cm and was grooved beforehand to have a guide groove for converged laser and thereon, a 20 nm-thick phase change recording film of AgInSbTe was formed similarly by a sputtering method. A 40 nm-thick dielectric thin film with the same composition as mentioned above was formed on the phase change recording film by a sputtering method to obtain an optical recording medium. The optical recording medium was set on a drive tester capable of evaluating properties of an optical disk such as DVD and the like and recording of signals with 30 MHz frequency was carried out at a linear velocity of 6.0 m/s by power of 6.0 mW. The recorded marks were rows of pits of 100 nm; duty ratio was 50%; the laser wavelength of the drive tester was 635 nm; the numerical aperture NA of a lens was 0.6; and the diffraction limit was 540 nm (theoretical resolution degree was 270 nm). After a fine silver particle thin film was formed again on the optical recording medium, on which such small marks were recorded as mentioned above, by a sputtering method in a vacuum apparatus under the same conditions as those of Comparative Example 1, an optical recording medium 2 bearing the fine silver particle thin film was obtained. The optical recording medium 2 was again set in the drive tester and while the medium being rotated at a linear velocity of 6.0 m/s, laser beam was converged on the guide groove of the recorded mark to try to read out the recorded marks under the condition of changing the reading-out power. Even if the reading-out power was increased to 8.0 mW, regeneration of the recorded signals could not be done.

### EXAMPLE 3

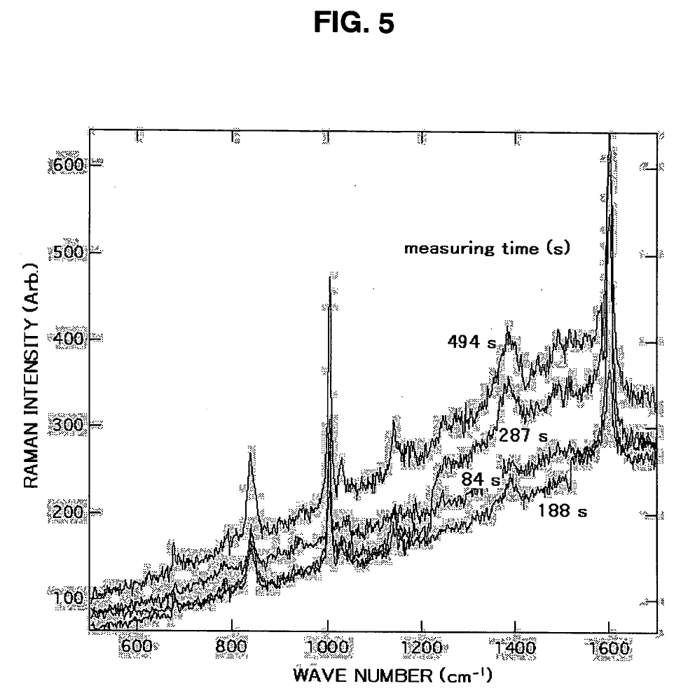

A fine silver particle thin film same as the sample 2 of the above-mentioned Example 1 was formed on a Si substrate by the same method as Example 1 to obtain an analysis sensor 1. Next, the analysis sensor 1 was immersed in a methanol solution containing 10⁻³ M of benzoic acid to carry out microscopic Raman spectrometry using excitation laser of 488 nm wavelength. The Raman signals were observed in reflection type arrangement. When the excitation laser of 488 nm wavelength was converged upon the surface of the analysis sensor 1 using an objective lens of NA 0.6, Raman signals of benzoic acid were obtained at once. The Raman signals scarcely showed any change with lapse of time and could be stably measured. The measurement results of the intensity of the Raman spectrum were shown in FIG. 5.

From these results, the analysis sensor 1 of the present invention was found capable of quantitatively analyzing benzoic acid.

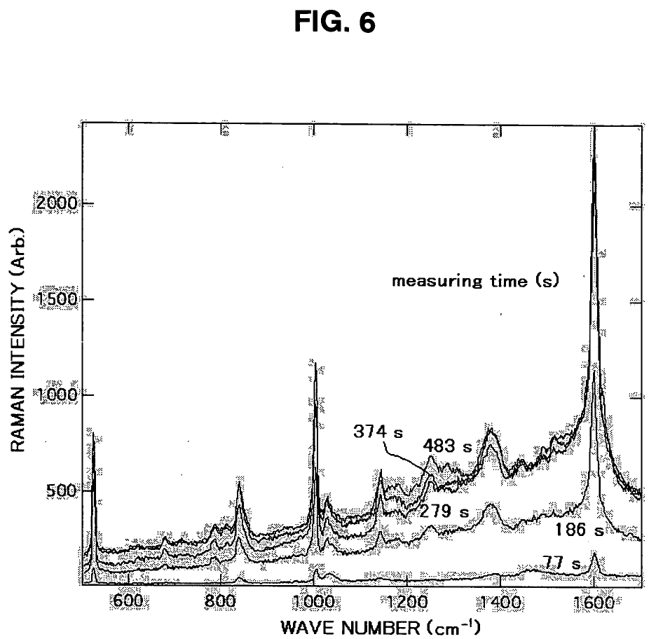

For comparison, a silver oxide thin film same as the sample 1 of the above-mentioned Example 1 was formed on a Si substrate to obtain an analysis sensor 2. The analysis sensor 2 was subjected to an experiment similar to Example 3. The Raman signal peaks attributed to benzoic acid changed with lapse of time and in the case of a long-term measurement, the peaks attributed to benzoic acid themselves disappeared and only the peaks supposedly attributed to carbon were left (FIG. 6). Accordingly, the analysis sensor 2 used in the comparative experiment was found impossible to quantitatively analyze benzoic acid.

### COMPARATIVE EXAMPLE 3

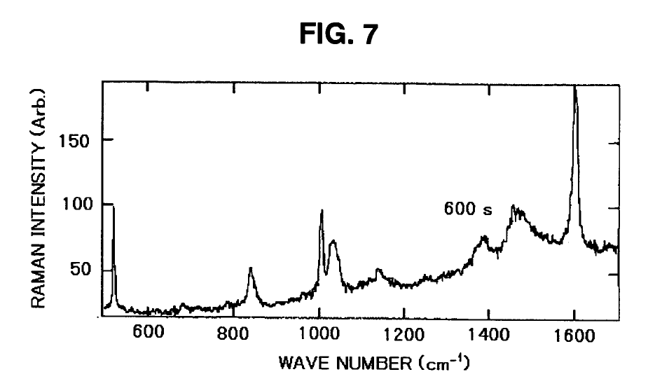

An analysis sensor 3 using the sample 4 of Comparative Example 1 was produced and Raman spectrum of benzoic acid was measured by the same method as Example 3. The height of the Raman peaks of benzoic acid was extremely low (FIG. 7). Accordingly, the analysis sensor 3 was found very inferior in the capability as a sensor.

### EXAMPLE 4

A clad layer on the surface of an optical fiber was removed by an etching treatment and a thin film same as the fine silver particle thin film (sample 2) of Example 1 was formed on the resulting fiber having only the remaining core part to obtain an optical fiber sample.

A detector was connected to an end surface of the fiber sample and Raman spectrophotometry was carried out in the low concentration benzoic acid solution similar to that described above. As a result, light diffusion was confirmed in the inside of the fiber and thus good Raman spectrophotometry was made possible. Further, excitation light beams made incident from the other end surface of the fiber sample and similar Raman spectrophotometry of benzoic acid was tried to obtain good Raman signals.

With respect to the surface plasmon-excitable thin film of fine noble metal particles according to the present invention, since particles having uniform and nanometer order particle diameters are distributed at appropriate intergranular distances, the thin film can stably supply surface plasmon to the nanometer range.

Accordingly, the surface plasmon-excitable thin film of fine noble metal particles according to the present invention can make it possible to detect signals from fine marks below the light diffraction limit by near field light beams or surface plasmon light beams while keeping the fine and stable particle size of the noble metal, so that a high density optical recording medium can be produced.

Since the surface plasmon-excitable thin film of fine noble metal particles according to the present invention can remarkably amplify the Raman lines by localized plasmon exhibited by the film, the sensitivity of an optical molecular sensor for identifying organic molecules using the Raman lines amplification can be enhanced and at the same time, the sensor can be miniaturized since a prism and other members are no longer necessary.

What is claimed is:

1. A surface plasmon-excitable fine granular thin film of a noble metal comprising uniformly distributed fine granules of the noble metal having an average particle diameter not exceeding 50 nm, which is obtained by a reducing treatment of a thin film of a noble metal oxide in a hydrogen-containing gas.

2. The surface plasmon-excitable fine granular thin film of a noble metal described in claim 1 characterized by a distribution of the fine granules of the metal with an intergranular distance of 10 to 30 nm.

3. The surface plasmon-excitable fine granular thin film of a noble metal described in claim 1 wherein the hydrogen-containing gas is a mixed gas of oxygen or a rare gas and hydrogen.

4. The surface plasmon-excitable fine granular thin film of a noble metal described in claim 3 wherein the proportion of the partial pressure of hydrogen to the total pressure of the hydrogen-containing gas is at least 0.4.

5. The surface plasmon-excitable fine granular thin film of a noble metal described in claim 1 wherein the noble metal is silver, platinum, palladium or an alloy thereof.

6. An optical recording medium comprising a layer of the surface plasmon-excitable fine granular thin film of a noble metal described in claim 1 and an optical recording layer.

7. The optical recording medium described in claim 6 wherein the optical recording layer is a phase-transition type optical recording layer.

8. An optical molecular sensor comprising the surface plasmon-excitable fine granular thin film of a noble metal described in claim 1 as formed on a substrate and characterized by utilization of the Raman optical amplification of localized surface plasmon exhibited by said surface plasmon-excitable fine granular thin film of a noble metal.

9. The optical molecular sensor described in claim 8 wherein the substrate is an optical fiber.
